(19) United States
(12) Patent Application Publication
(10) Pub. No.: US 2026/0351941 A1
(43) Pub. Date: Nov. 5, 2026

(54) BUSBAR

(71) Applicant: Yazaki Corporation, Tokyo (JP)

(72) Inventors: Masayo MATSUURA, Shizuoka (JP); Takuto Mishige, Shizuoka (JP); Kenji Segawa, Shizuoka (JP); Takanori Kanamori, Shizuoka (JP); Junya Ishida, Shizuoka (JP)

(73) Assignee: Yazaki Corporation, Tokyo (JP)

(21) Appl. No.: 19/659,236

(22) Filed: Apr. 27, 2026

(30) Foreign Application Priority Data
May 1, 2025 (JP) 2025-076221

(51) Int. Cl. H02G 5/00

(52) U.S. Cl. CPC H02G 5/00

(57) ABSTRACT

A busbar includes: a first flat plate portion and a second flat plate portion which are two conductive flat plate portions formed in a flat plate shape; and a conductive first bent portion connecting a first end of the first flat plate portion and a first end of the second flat plate portion, the first bent portion obtained by bending the second flat plate portion toward the first flat plate portion in the plate thickness direction of the first flat plate portion, in which a thickness of the first bent portion is thinner than a thickness of the first flat plate portion and thinner than a thickness of the second flat plate portion from a first end to a second end of the first bent portion in the width direction the first bent portion.

### CROSS-REFERENCE TO RELATED APPLICATION(S)

The present application claims priority to and incorporates by reference the entire contents of Japanese Patent Application No. 2025-076221 filed in Japan on May 1, 2025.

### BACKGROUND OF THE INVENTION

### 1. Field of the Invention

The present invention relates to a busbar.

### 2. DESCRIPTION OF THE RELATED ART

As a conventional busbar, for example, JP 2019 - 087 668 A discloses a positive electrode busbar in which a joining surface of a distal end that is bent in an L shape from a body is joined to an object to be joined. A hole is formed across the body and the distal end at a bent portion connecting the distal end and the body of the positive electrode busbar. The distal end is well bent with respect to the body due to the hole, and thus the positive electrode busbar of JP 2019 – 087 668 A closely adheres to the object to be joined. In the positive electrode busbar, when current flows through conductor portions on both sides of the hole, induction magnetic fields caused by current flowing through respective conductor portions are canceled by the hole.

Incidentally, in conventional busbars, for example, deformation of a busbar due to heat or assembly tolerance between a busbar and mating members may affect the connection between the busbar and the mating member. It is desired to make it possible to suppress deformation due to heat or assembly tolerance from affecting the connection between the busbar and the mating members.

### SUMMARY OF THE INVENTION

The objective of the present invention is to provide a busbar capable of suppressing the influence of deformation due to heat or assembly tolerance on connection between the busbar and the mating members.

In order to achieve the above mentioned object, a busbar according to one aspect of the present invention includes a first flat plate portion and a second flat plate portion which are two conductive flat plate portions formed in a flat plate shape; and a conductive first bent portion connecting a first end of the first flat plate portion and a first end of the second flat plate portion, the first bent portion obtained by bending the second flat plate portion toward the first flat plate portion in a plate thickness direction of the first flat plate portion, wherein a thickness of the first bent portion is thinner than a thickness of the first flat plate portion and thinner than a thickness of the second flat plate portion from a first end to a second end of the first bent portion in a width direction of the first bent portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connection state between a busbar according to a first embodiment and a mating member;

FIG. 2 is a perspective view of the busbar according to the first embodiment;

FIG. 3 is a perspective view of the busbar according to the first embodiment;

FIG. 4 is a perspective view of the busbar according to the first embodiment;

FIG. 5 is an enlarged view illustrating the connection state between the busbar according to the first embodiment and the mating member;

FIG. 6 is a side view of the busbar according to the first embodiment;

FIG. 7 is a perspective view of a busbar according to a second embodiment;

FIG. 8 is a perspective view of the busbar according to the second embodiment;

FIG. 9 is a perspective view of a busbar according to a third embodiment; and

FIG. 10 is a perspective view of the busbar according to the third embodiment.

### DETAILED DESCRIPTION OF THE PREFERRED EMBODIMENTS

Hereinafter, busbars according to embodiments of the present invention will be described in detail with reference to the drawings. Note that the invention is not limited by the embodiments. In addition, components in the following embodiments include those that can be easily conceived of by those skilled in the art and those that are substantially the same.

### First Embodiment

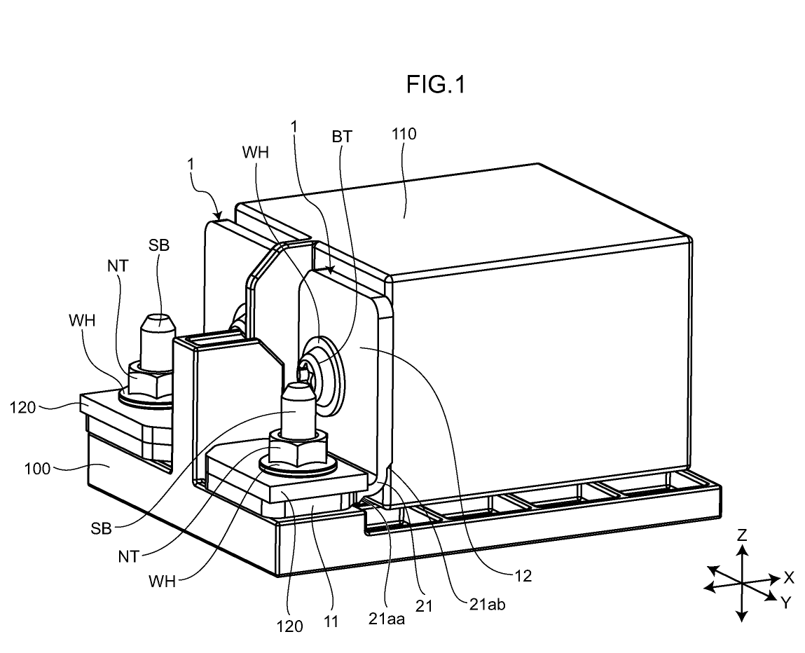

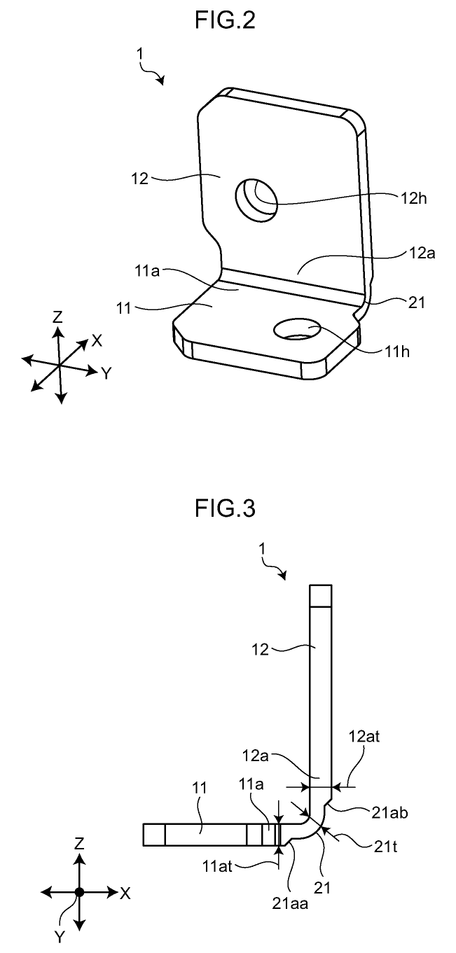

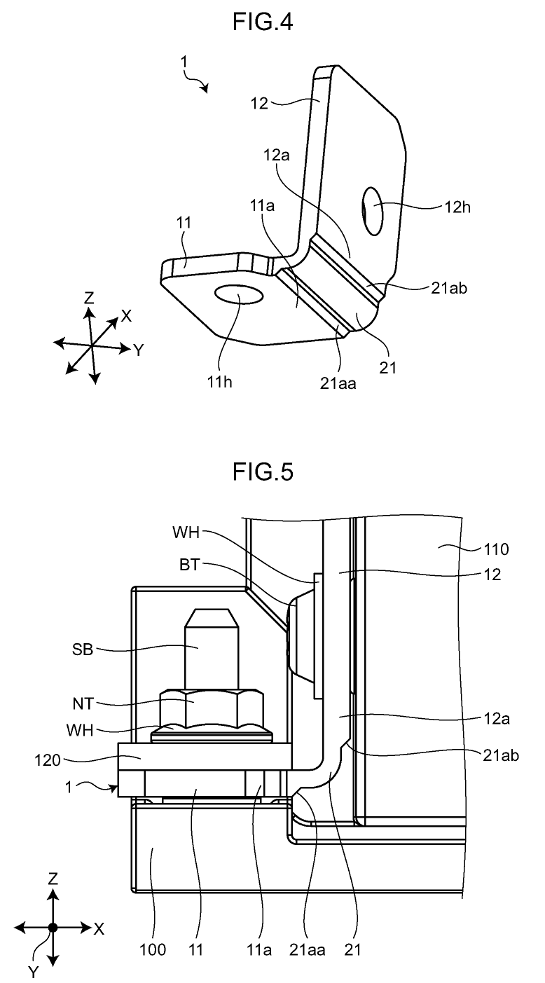

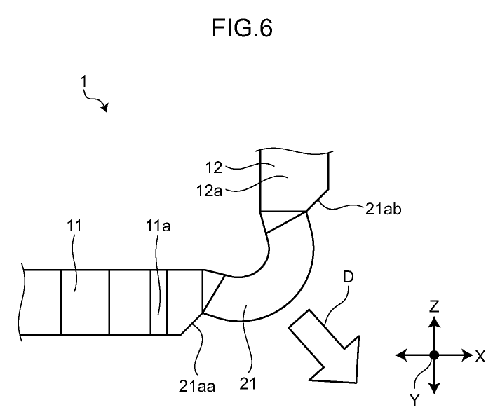

A first embodiment will be described with reference to FIGS. 1-6. FIG. 1 is a perspective view illustrating a connection state between a busbar according to a first embodiment and a mating member, FIG. 2 is a perspective view of the busbar according to the first embodiment, FIG. 3 is a perspective view of the busbar according to the first embodiment, FIG. 4 is a perspective view of the busbar according to the first embodiment, FIG. 5 is an enlarged view illustrating the connection state between the busbar according to the first embodiment and the mating member, and FIG. 6 is a side view of the busbar according to the first embodiment.

A busbar 1 according to the first embodiment is a connection member having conductivity, is accommodated in a housing of an electrical connection box such as a junction box, and electrically connects at least two mating members. Examples of the mating members include an electronic component such as a relay or a conductive connection member. As illustrated in FIG. 1, the mating members in the first embodiment are a relay 110 and a busbar 120 different from the busbar 1. The relay 110 is a member that performs on/off control and switching of an electric circuit by receiving an electric signal from the outside. The busbar 120 is a conductive connection member connected to another electric device (not illustrated). In the first embodiment, the busbar 120 is formed in a flat plate shape.

As illustrated in FIG. 2, the busbar 1 includes a first flat plate portion 11 and a second flat plate portion 12 which are two conductive flat plate portions, and a conductive first bent portion 21 connecting a first end 11a of the first flat plate portion 11 and a first end 12a of the second flat plate portion 12.

Each of the first flat plate portion 11 and the second flat plate portion 12 is formed in a rectangular flat plate shape. The first flat plate portion 11 has a through hole 11h penetrating the first flat plate portion 11 in the plate thickness direction. The second flat plate portion 12 also has a through hole 12h penetrating the second flat plate portion 12 in the plate thickness direction. The through hole 11h and the through hole 12h are holes through which fastening members such as bolts are inserted.

In the first bent portion 21, the second flat plate portion 12 is bent in the plate thickness direction of the first flat plate portion 11 toward the first flat plate portion 11. That is, the busbar 1 is formed in a plate shape having a substantially L shape as a whole. For example, the busbar 1 is formed in a substantially L-shaped plate shape by performing various types of processing such as bending on one sheet metal.

In the present specification, the direction in which the first flat plate portion 11 and the first bent portion 21 are connected is referred to as a first direction X. Furthermore, the width direction of the first flat plate portion 11, which is a direction intersecting the first direction X, is referred to as a second direction Y. The thickness direction of the first flat plate portion 11, which is the direction intersecting both the first direction X and the second direction Y, is referred to as a third direction Z. In the first embodiment, the first direction X, the second direction Y, and the third direction Z are orthogonal to each other.

As illustrated in FIG. 3, in the busbar 1, a thickness 21t of the first bent portion 21 is thinner than a thickness 11at of the first flat plate portion 11 and a thickness 12at of the second flat plate portion 12 from a first end to a second end of the first bent portion 21 in the width direction (second direction Y). That is, the busbar 1 according to the first embodiment has a structure in which the first bent portion 21 is biased and the plate thickness of the first bent portion 21 is locally thin. Herein, the thickness 11at of the first flat plate portion 11 refers to the length (thickness) of the first end 11a of the first flat plate portion 11 in the third direction Z. The thickness 12at of the second flat plate portion 12 is a length (thickness) of the first end 12a of the second flat plate portion 12 in the first direction X. The thickness 21t of the first bent portion 21 is a length from a first main surface (front side) to a second main surface (back side) of the first bent portion 21. Incidentally, the main surfaces of the first bent portion 21 refer to two surfaces having the largest areas among the surfaces included in the first bent portion 21.

As illustrated in FIGS. 3 and 4, in the busbar 1 of the first embodiment, the back side of the first bent portion 21 is recessed with respect to the first end 11a of the first flat plate portion 11 and the first end 12a of the second flat plate portion 12. That is, only one side of the first bent portion 21 of the busbar 1 of the first embodiment is recessed. In other words, the front side of the first bent portion 21 is continuous with the first end 11a of the first flat plate portion 11 and the first end 12a of the second flat plate portion 12 without an inclined surface or a step interposed therebetween, whereas the back side of the first bent portion 21 is recessed with respect to the first end 11a of the first flat plate portion 11 and the first end 12a of the second flat plate portion 12 via an inclined surface (or a step). The end of the first bent portion 21 on the first flat plate portion 11 side is formed in a tapered shape in which the back side is inclined in such a manner as to be gradually thinner from the first end 11a side of the first flat plate portion 11, and the end of the first bent portion 21 on the second flat plate portion 12 side is formed in a tapered shape in which the back side is inclined in such a manner as to be gradually thinner from the first end 12a side of the second flat plate portion 12.

That is, the end of the first bent portion 21 on the first end 11a side of the first flat plate portion 11 has, on the back side, an inclined surface 21aa inclined from the first end 11a side of the first flat plate portion 11 toward the first bent portion 21. Furthermore, the end of the first bent portion 21 on the first end 12a side of the second flat plate portion 12 has, on the back side, an inclined surface 21ab inclined from the first end 12a side of the second flat plate portion 12 toward the first bent portion 21. Incidentally, the back side of the first bent portion 21 refers to a surface on the outer side (outer peripheral side) of the first bent portion 21 bent in an L shape. Likewise, the front side of the first bent portion 21 refers to a surface that is on the opposite side to the back side and is on the inner side (inner peripheral side) of the first bent portion 21.

As illustrated in FIG. 5, a stud bolt SB is held on a bottom wall 100 of a housing or the like of the electrical connection box, and is provided in such a manner as to protrude from the wall surface of the bottom wall 100. A box-shaped relay 110 is also placed on the bottom wall 100. In this example, the relay 110 is disposed at a position adjacent to the stud bolt SB in the first direction X.

The stud bolt SB is inserted into the through hole 11h of the first flat plate portion 11. The busbar 120 that is different from the busbar 1 has a through hole penetrating the busbar 120 in the plate thickness direction, and the stud bolt SB is also inserted into the through hole. The first flat plate portion 11 of the busbar 1 and the busbar 120 are secured to the bottom wall 100 with a nut NT screwed to the stud bolt in a state of being overlapped in the plate thickness direction (third direction Z) of the first flat plate portion 11. With this configuration, the first flat plate portion 11 and the busbar 120 are electrically connected. In the first embodiment, a washer WH that is an intermediate member is provided between the nut NT and the busbar 120.

A bolt BT is inserted into the through hole 12h of the second flat plate portion 12. The bolt BT is screwed into a terminal hole formed in a side surface of the relay 110 in a state of being inserted into the through hole 12h. With this configuration, the second flat plate portion 12 and the relay 110 are electrically connected. In the first embodiment, a washer WH is provided between the head of the bolt BT and the second flat plate portion 12.

In the busbar 1 according to the first embodiment, the load required for deforming the first bent portion 21 can be reduced by making the thickness of the first bent portion 21 thinner than the thickness of the first flat plate portion 11 or the thickness of the second flat plate portion. For example, when the busbar 1 is connected to mating members (the relay 110 and the busbar 120), the load required for deforming the first bent portion 21 is low, and thus the first bent portion 21 can easily absorb assembly tolerance such as deviation of the fastening position, which can reduce the load on the fastening portion (such as the stud bolt SB). In addition, by reducing the load required for deforming the first bent portion 21, it is possible to suppress deformation of the entire busbar 1 (buckling or the like of the flat plate portions). For example, when the temperature of the busbar 1 connected to a mating member (the relay 110 or the busbar 120) becomes high, the busbar 1 expands by heat. The first bent portion 21 can absorb deformation of the entire busbar 1 due to thermal expansion by further bending in such a manner as to protrude outward as indicated by an arrow D in FIG. 6, and can thereby suppress deformation of the entire busbar 1 (buckling or the like of the flat plate portion).

In the first embodiment described above, an example in which the back side of the first bent portion 21 is recessed with respect to the first end 11a of the first flat plate portion 11 and the first end 12a of the second flat plate portion 12 has been described; however, it is not limited thereto. For example, in the busbar 1, the front side of the first bent portion 21 may be recessed with respect to the first end 11a of the first flat plate portion 11 and the first end 12a of the second flat plate portion 12.

As described above, the busbar 1 according to the first embodiment includes the first flat plate portion 11 and the second flat plate portion 12 which are two conductive flat plate portions formed in a flat plate shape, and the conductive first bent portion 21 that connects the first end 11a of the first flat plate portion 11 and the first end 12a of the second flat plate portion 12, the first bent portion 21 obtained by bending the second flat plate portion 12 toward the first flat plate portion 11 in the plate thickness direction of the first flat plate portion 11, in which the thickness 21t of the first bent portion 21 is thinner than the thickness 11at of the first flat plate portion 11 and thinner than the thickness 12at of the second flat plate portion 12 from the first end to the second end of the first bent portion 21 in the width direction of the first bent portion 21.

In the busbar 1 according to the first embodiment, by making the thickness 21t of the first bent portion 21 thinner than those of the first flat plate portion 11 and the second flat plate portion 12, for example, deformation of the busbar 1 due to heat can be absorbed by deformation of the first bent portion 21, and thus it is possible to suppress deformation of the busbar 1 due to heat from affecting the connection between the busbar 1 and the mating members (the relay 110, the busbar 120, or others). For example, the busbar 1 of the first embodiment can suppress buckling of the busbar 1 or a connection failure due to deformation of the busbar 1 caused by heat. In addition, since deformation of the first bent portion 21 is facilitated, it is possible to allow the first bent portion 21 to absorb assembly tolerance when the busbar 1 is fastened to the mating members.

In the busbar 1 according to the first embodiment, the end of the first bent portion 21 on the first flat plate portion 11 side is formed in a tapered shape in such a manner as to be gradually thinned from the first end 11a side of the first flat plate portion 11, and the end of the first bent portion 21 on the second flat plate portion 12 side is formed in a tapered shape in such a manner as to be gradually thinned from the first end 12a side of the second flat plate portion 12.

In the busbar 1 according to the first embodiment, with both ends of the first bent portion 21 tapered, the surface area of the busbar 1 can be increased by the area of the inclined surface, which can improve the heat dissipation of the busbar 1.

In the busbar 1 according to the first embodiment, one surface of the first bent portion 21 is recessed with respect to the first end 11a of the first flat plate portion 11 and the first end 12a of the second flat plate portion 12.

The busbar 1 according to the first embodiment can facilitate deformation of the first bent portion 21 by having one surface recessed, and, for example, assembly tolerance when the busbar 1 is fastened to the mating members can be absorbed by the first bent portion 21. In addition, in the busbar 1 according to the first embodiment, by having one surface recessed at both ends of the first bent portion 21, for example, the surface area of the busbar 1 can be increased by the areas of a step surface or an inclined surface, and thus the heat dissipation of the busbar 1 can be improved.

In addition, in the busbar 1 according to the first embodiment, two of the flat plate portions have through-holes 11h and 12h each penetrating the corresponding flat plate portion in its plate thickness direction.

In the busbar 1 according to the first embodiment, the stud bolt SB, the bolt TB, or the like is inserted into each of the through hole 11h and the through hole 12h and fastened using the nut NT or the like, whereby the busbar 1 and the mating members can be fastened together. At this point, since deformation of the bent portion (first bent portion 21) is facilitated, assembly tolerance and the like when the busbar 1 is fastened to the mating members can be absorbed by the first bent portion 21.

### Second Embodiment

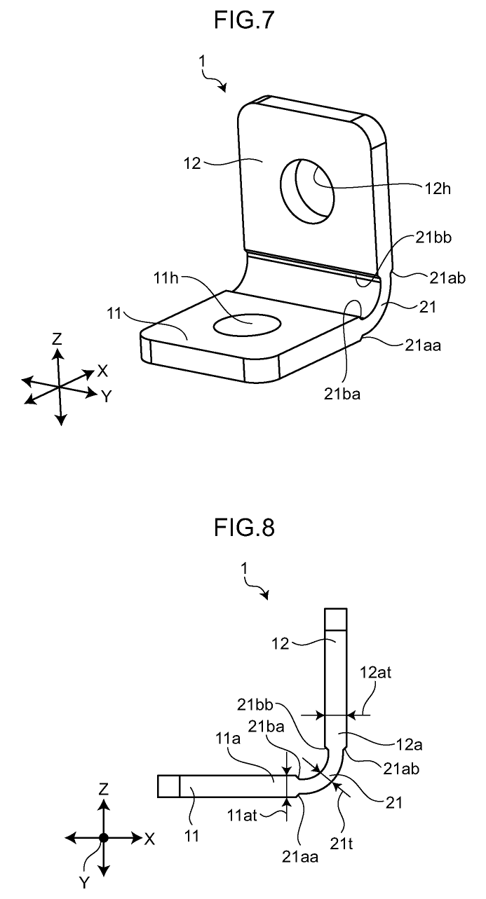

Next, a second embodiment will be described with reference to FIGS. 7 and 8. In the second embodiment, components having functions similar to those described in the first embodiment are denoted by the same reference numerals, and redundant description is omitted. FIG. 7 is a perspective view of a busbar according to the second embodiment, and FIG. 8 is a perspective view of the busbar according to the second embodiment. The second embodiment is different from the first embodiment in that, for example, both sides of a first bent portion 21 are recessed with respect to a first end 11a of a first flat plate portion 11 and a first end 12a of a second flat plate portion 12. That is, in a busbar 1 of the second embodiment, both sides of the first bent portion 21 are recessed with respect to the first end 11a of the first flat plate portion 11 and the first end 12a of the second flat plate portion 12 via an inclined surface (or a step) interposed therebetween.

As illustrated in FIG. 7, the busbar 1 according to the second embodiment has a structure in which the plate thickness of the first bent portion 21 is uneven and locally thin. As illustrated in FIG. 8, in the busbar 1 according to the second embodiment, the end of the first bent portion 21 on the first flat plate portion 11 side is formed in a tapered shape in which both sides (both of main surfaces) are inclined in such a manner as to be gradually thinner from the first end 11a side of the first flat plate portion 11, and the end of the first bent portion 21 on the second flat plate portion 12 side is formed in a tapered shape in which both of the sides are inclined in such a manner as to be gradually thinner from the first end 12a side of the second flat plate portion 12.

That is, the end of the first bent portion 21 on the first end 11a side of the first flat plate portion 11 has, on the back side, an inclined surface 21aa inclined from the first end 11a side of the first flat plate portion 11 toward the first bent portion 21 and, on the front side, an inclined surface 21ba inclined from the first end 11a side of the first flat plate portion 11 toward the first bent portion 21. The end of the first bent portion 21 on the first end 12a side of the second flat plate portion 12 has, on the back side, an inclined surface 21ab inclined from the first end 12a side of the second flat plate portion 12 toward the first bent portion 21 and, on the front side, an inclined surface 21bb inclined from the first end 12a side of the second flat plate portion 12 toward the first bent portion 21.

As described above, in the busbar 1 according to the second embodiment, both sides of the first bent portion 21 are recessed with respect to the first end 11a of the first flat plate portion 11 and the first end 12a of the second flat plate portion 12.

In the busbar 1 of the second embodiment, deformation of the first bent portion 21 is facilitated by having both sides recessed, and, for example, assembly tolerance when the busbar 1 is fastened to the mating members can be absorbed by the first bent portion 21. In the busbar 1 of the second embodiment, the surface area of the busbar 1 can be increased by having both sides recessed at both ends of the first bent portion 21, whereby the heat dissipation of the busbar 1 can be improved.

### Third Embodiment

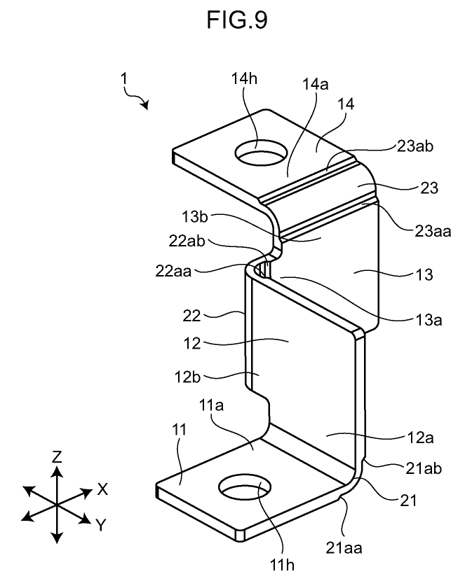

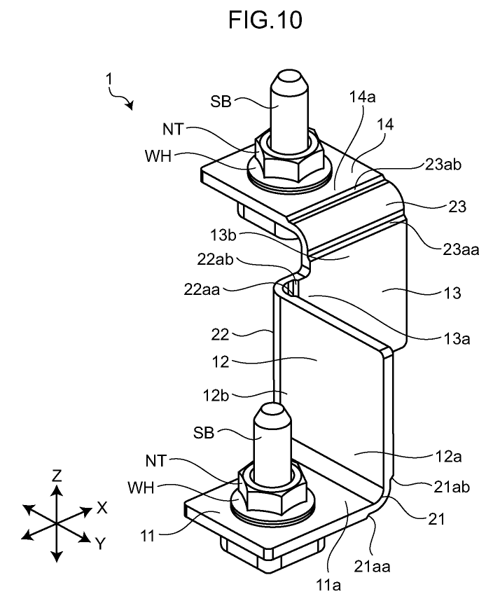

Next, a third embodiment will be described with reference to FIGS. 9 and 10. In the third embodiment, components having functions similar to those described in the first embodiment are denoted by the same reference numerals, and redundant description is omitted. FIG. 9 is a perspective view of a busbar according to a third embodiment, and FIG. 10 is a perspective view of the busbar according to the third embodiment. The third embodiment is different from the first embodiment in that, for example, a busbar 1 includes four flat plate portions (first flat plate portion 11, second flat plate portion 12, third flat plate portion 13, and fourth flat plate portion 14) and three bent portions (first bent portion 21, second bent portion 22, and third bent portion 23). Furthermore, another different from the first embodiment is that, for example, the through-hole 12h is not formed in the second flat plate portion 12 and that a through-hole 14h is formed in the fourth flat plate portion 14.

As illustrated in FIG. 9, in addition to the first flat plate portion 11 and the second flat plate portion 12, the busbar 1 of the third embodiment further includes the third flat plate portion 13 that is a third conductive flat plate portion formed in a flat plate shape and the fourth flat plate portion 14 that is a fourth conductive flat plate portion formed in a flat plate shape. In the third embodiment, the plate thickness direction of the third flat plate portion 13 corresponds to the second direction Y. The plate thickness direction of the fourth flat plate portion corresponds to the third direction Z.

The busbar 1 of the third embodiment further includes the conductive second bent portion 22 and the conductive third bent portion 23 in addition to the first bent portion 21. The second bent portion 22 connects a first end 13a of the third flat plate portion 13 and a second end 12b of the second flat plate portion 12 different from the first end 12a, and bends the third flat plate portion 13 toward the second flat plate portion 12 in the plate thickness direction of the second flat plate portion 12. The third bent portion 23 connects a first end 14a of the fourth flat plate portion 14 and a second end 13b of the third flat plate portion 13 different from the first end 13a, and bends the fourth flat plate portion 14 toward the third flat plate portion 13 in the plate thickness direction of the third flat plate portion 13.

In the busbar 1 of the third embodiment, each of the third flat plate portion 13 and the fourth flat plate portion 14 is formed in a rectangular flat plate shape similarly to the first flat plate portion 11 and the second flat plate portion 12.

The second bent portion 22 connects the second end 12b of the second flat plate portion 12 in the second direction Y and the first end 13a of the third flat plate portion 13 in the first direction X. In the second bent portion 22, the third flat plate portion 13 is bent, with respect to the second flat plate portion 12, to the side opposite to the side to which the first flat plate portion 11 is bent with respect to the second flat plate portion 12.

The third bent portion 23 connects the second end 13b of the third flat plate portion 13 in the third direction Z and the first end 14a of the fourth flat plate portion 14 in the second direction Y. In the third bent portion 23, the fourth flat plate portion 14 is bent, with respect to the third flat plate portion 13, to the side opposite to the side to which the second flat plate portion 12 is bent with respect to the third flat plate portion 13.

In the busbar 1, the thickness of the first bent portion 21 is thinner than the thickness of the first flat plate portion 11 and the thickness of the second flat plate portion 12 from a first end to a second end of the first bent portion 21 in the width direction (second direction Y).

Likewise, the thickness of the second bent portion 22 is thinner than the thickness of the second flat plate portion 12 and the thickness of the third flat plate portion 13 from a first end to a second end of the second bent portion 22 in the width direction (third direction Z). The thickness of the second flat plate portion 12 herein is the length (thickness) of the second end 12b of the second flat plate portion 12 in the first direction X, and the thickness of the third flat plate portion 13 is the length (thickness) of the first end 13a of the third flat plate portion 13 in the second direction Y.

Likewise, the thickness of the third bent portion 23 is thinner than the thickness of the third flat plate portion 13 and the thickness of the fourth flat plate portion 14 from a first end to a second end of the third bent portion 23 in the width direction (first direction X). The thickness of the third flat plate portion 13 herein is the length (thickness) of the second end 13b of the third flat plate portion 13 in the second direction Y, and the thickness of the fourth flat plate portion 14 is the length (thickness) of the first end 14a of the fourth flat plate portion 14 in the third direction Z.

That is, the busbar 1 according to the third embodiment has a structure in which the plate thicknesses of the first bent portion 21, the second bent portion 22, and the third bent portion 23 are uneven and are locally thin.

Incidentally, the thickness of the second bent portion 22 is the length from a first main surface (front side) to a second main surface (back side) of the second bent portion 22. The thickness of the third bent portion 23 is the length from a first main surface (front side) to a second main surface (back side) of the third bent portion 23. Incidentally, the main surfaces of the second bent portion 22 refer to two surfaces having the largest areas among the surfaces included in the second bent portion 22. Incidentally, the main surfaces of the third bent portion 23 refer to two surfaces having the largest areas among the surfaces included in the third bent portion 23.

In the busbar 1 of the third embodiment, the back side of the second bent portion 22 is recessed with respect to the second end 12b of the second flat plate portion 12 and the first end 13a of the third flat plate portion 13. The end of the second bent portion 22 on the second flat plate portion 12 side is formed in a tapered shape in which the back side is inclined in such a manner as to be gradually thinner from the second end 12b side of the second flat plate portion 12, and the end of the second bent portion 22 on the third flat plate portion 13 side is formed in a tapered shape in which the back side is inclined in such a manner as to be gradually thinner from the first end 13a side of the third flat plate portion 13.

That is, the end of the second bent portion 22 on the second end 12b side of the second flat plate portion 12 has, on the back side, an inclined surface 22aa inclined from the second end 12b side of the second flat plate portion 12 toward the second bent portion 22. The end of the second bent portion 22 on the first end 13a side of the third flat plate portion 13 has, on the back side, an inclined surface 22ab inclined from the first end 13a side of the third flat plate portion 13 toward the second bent portion 22. Incidentally, the back side of the second bent portion 22 refers to a surface on the inner side (inner peripheral side) of the second bent portion 22 bent in an L shape. The front side of the second bent portion 22 refers to a surface opposite to the back side of the second bent portion 22, and is a surface on the outer side (outer peripheral side) of the second bent portion 22 bent in an L shape.

In the busbar 1 of the third embodiment, the back side of the third bent portion 23 is recessed with respect to the second end 13b of the third flat plate portion 13 and the first end 14a of the fourth flat plate portion 14. The end of the third bent portion 23 on the third flat plate portion 13 side is formed in a tapered shape in which the back side is inclined in such a manner as to be gradually thinner from the second end 13b side of the third flat plate portion 13, and the end of the third bent portion 23 on the fourth flat plate portion 14 side is formed in a tapered shape in which the back side is inclined in such a manner as to be gradually thinner from the first end 14a side of the fourth flat plate portion 14.

That is, the end of the third bent portion 23 on the second end 13b side of the third flat plate portion 13 has, on the back side, an inclined surface 23aa inclined from the second end 13b side of the third flat plate portion 13 toward the third bent portion 23. The end of the third bent portion 23 on the first end 14a side of the fourth flat plate portion 14 has, on the back side, an inclined surface 23ab inclined from the first end 14a side of the fourth flat plate portion 14 toward the third bent portion 23. Incidentally, the back side of the third bent portion 23 refers to a surface on the outer side (outer peripheral side) of the third bent portion 23 bent in an L shape. Here, the front side of the third bent portion 23 is a surface opposite to the back side, and is a surface on the inner side (inner peripheral side) of the third bent portion 23 bent in an L shape.

As illustrated in FIG. 10, a stud bolt SB is inserted into each of a through hole 11h and a through hole 14h, and the busbar 1 is fastened and secured to mating members (not illustrated) by nuts NT and washers WH.

In the busbar 1 according to the third embodiment, the load required for deforming the bent portions (the first bent portion 21, the second bent portion 22, and the third bent portion 23) can be reduced by making the thicknesses of the bent portions thinner than the thicknesses of the flat plate portions (the first flat plate portion 11, the second flat plate portion 12, the third flat plate portion 13, and the fourth flat plate portion 14). For example, in the busbar 1 according to the third embodiment, when the busbar 1 is connected to mating members (the relay 110, the busbar 120, or others), the load required for deforming the bent portions is low, and thus the bent portions can easily absorb assembly tolerance such as deviation of the fastening position, which can reduce the load on the fastening portions (such as the stud bolts SB). In addition, by reducing the load required for deforming the bent portions, it is possible to suppress deformation of the entire busbar 1 (buckling or the like of the flat plate portions). For example, when the temperature of the busbar 1 connected to a mating member (a relay 110, a busbar 120, or others) becomes high, the busbar 1 expands by heat. At this point, the bent portions can absorb deformation of the entire busbar 1 due to thermal expansion by further bending in such a manner as to protrude outward, and can thereby suppress deformation of the entire busbar 1 (buckling or the like of the flat plate portions).

In the third embodiment described above, the busbar 1 including the four flat plate portions (the first flat plate portion 11, the second flat plate portion 12, the third flat plate portion 13, and the fourth flat plate portion 14) and the three bent portions (the first bent portion 21, the second bent portion 22, and the third bent portion 23) has been described as an example; however, it is not limited thereto. For example, the busbar 1 may include three flat plate portions and two bent portions. Alternatively, for example, the busbar 1 may include five or more flat plate portions and four or more bent portions. In these cases, each of the bent portions is provided in such a manner as to connect two flat plate portions.

As described above, the busbar 1 according to the third embodiment further includes: the third flat plate portion 13 that is the third conductive flat plate portion formed in a flat plate shape; and the conductive second bent portion 22 that connects the first end 13a of the third flat plate portion 13 and the second end 12b of the second flat plate portion 12 different from the first end 12a and bends the third flat plate portion 13 toward the second flat plate portion 12 in the plate thickness direction of the second flat plate portion 12, in which the thickness of the second bent portion 22 is thinner than the thickness of the second flat plate portion 12 and thinner than the thickness of the third flat plate portion 13 from the first end to the second end of the second bent portion 22 in the width direction of the second bent portion 22.

In addition, the busbar 1 according to the third embodiment further includes: the fourth flat plate portion 14 that is the fourth conductive flat plate portion formed in a flat plate shape; and the conductive third bent portion 23 that connects the first end 14a of the fourth flat plate portion 14 and the second end 13b of the third flat plate portion 13 different from the first end 13a, and bends the fourth flat plate portion 14 toward the third flat plate portion 13 in the plate thickness direction of the third flat plate portion 13, in which the thickness of the third bent portion 23 is thinner than the thickness of the third flat plate portion 13 and thinner than the thickness of the fourth flat plate portion 14 from the first end to the second end of the third bent portion 23 in the width direction of the third bent portion 23.

In the busbar 1 of the third embodiment, deformation of the busbar 1 due to heat is absorbed by deformation of the plurality of bent portions (the first bent portion 21, the second bent portion 22, and the third bent portion 23), which can suppress the deformation of the busbar 1 due to heat from affecting the connection between the busbar 1 and mating members. In addition, since deformation of the plurality of bent portions is facilitated, it is possible to allow the individual bent portions to absorb the assembly tolerance when the busbar 1 is fastened to mating members, and thus the assembly workability can be improved.

The content disclosed in the above embodiments can be implemented in combination as appropriate.

A busbar according to an aspect of the present embodiment has an effect of suppressing influence of deformation due to heat or assembly tolerance on connection between the busbar and the mating members.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A busbar comprising:
a first flat plate portion and a second flat plate portion which are two conductive flat plate portions formed in a flat plate shape; and
a conductive first bent portion connecting a first end of the first flat plate portion and a first end of the second flat plate portion, the first bent portion obtained by bending the second flat plate portion toward the first flat plate portion in a plate thickness direction of the first flat plate portion, wherein
a thickness of the first bent portion is thinner than a thickness of the first flat plate portion and thinner than a thickness of the second flat plate portion from a first end to a second end of the first bent portion in a width direction of the first bent portion.

2. The busbar according to claim 1, wherein
an end of the first bent portion on the first flat plate portion side is formed in a tapered shape in such a manner as to be gradually thinner from the first end side of the first flat plate portion, and
an end of the first bent portion on the second flat plate portion side is formed in a tapered shape in such a manner as to be gradually thinner from the first end side of the second flat plate portion.

3. The busbar according to claim 1, wherein
one side of the first bent portion is recessed with respect to the first end of the first flat plate portion and the first end of the second flat plate portion.

4. The busbar according to claim 2, wherein
one side of the first bent portion is recessed with respect to the first end of the first flat plate portion and the first end of the second flat plate portion.

5. The busbar according to claim 1, wherein
both sides of the first bent portion are recessed with respect to the first end of the first flat plate portion and the first end of the second flat plate portion.

6. The busbar according to claim 2, wherein
both sides of the first bent portion are recessed with respect to the first end of the first flat plate portion and the first end of the second flat plate portion.

7. The busbar according to claim 1, further comprising:
a third flat plate portion that is a third conductive flat plate portion formed in a flat plate shape; and
a conductive second bent portion that connects a first end of the third flat plate portion and a second end of the second flat plate portion, the second end being different from the first end of the second flat plate portion, and bends the third flat plate portion toward the second flat plate portion in a plate thickness direction of the second flat plate portion, wherein
a thickness of the second bent portion is thinner than a thickness of the second flat plate portion and is thinner than a thickness of the third flat plate portion from a first end to a second end of the second bent portion in a width direction of the second bent portion.

8. The busbar according to claim 7, further comprising:
a fourth flat plate portion that is a fourth conductive flat plate portion formed in a flat plate shape; and
a conductive third bent portion that connects a first end of the fourth flat plate portion and a second end of the third flat plate portion, the second end being different from the first end of the third flat plate portion, and bends the fourth flat plate portion toward the third flat plate portion in a plate thickness direction of the third flat plate portion, wherein
a thickness of the third bent portion is thinner than a thickness of the third flat plate portion and is thinner than a thickness of the fourth flat plate portion from a first end to a second end of the third bent portion in a width direction of the third bent portion.

9. The busbar according to claim 1, wherein
two of the flat plate portions each have a through hole penetrating the flat plate portion itself in a plate thickness direction of the flat plate portion itself.

10. The busbar according to claim 2, wherein
two of the flat plate portions each have a through hole penetrating the flat plate portion itself in a plate thickness direction of the flat plate portion itself.
